(19) United States
(12) Patent Application Publication
(10) Pub. No.: US 2018/0103487 A1
(43) Pub. Date: Apr. 12, 2018

(54) DYNAMIC SELECTION OF CONTROL RESPONSE FRAME PARAMETERS

(71) Applicant: QUALCOMM Incorporated, San Diego, CA (US)

(72) Inventors: Alfred Asterjadhi, San Diego, CA (US); George Cherian, San Diego, CA (US); Abhishek Pramod Patil, San Diego, CA (US); Alireza Raissinia, Monte Sereno, CA (US); Ravi Gidvani, Fremont, CA (US); James Simon Cho, Mountain View, CA (US)

(21) Appl. No.: 15/730,709

(22) Filed: Oct. 11, 2017

Related U.S. Application Data
(60) Provisional application No. 62/407,475, filed on Oct. 12, 2016.
(60) Provisional application No. 62/417,250, filed on Nov. 3, 2016.

(51) Int. Cl. H04W 74/00; H04W 24/02

(52) U.S. Cl. CPC H04W 74/002; H04W 84/12; H04W 24/02

(57) ABSTRACT

A wireless device (e.g., a station (STA)) may receive a transmission soliciting a control transmission (e.g., a soliciting transmission). The STA may identify a transmission parameter indicator, which may indicate a change in one or more parameters in a control response transmission parameter set (e.g., a set of parameters used for control transmissions in response to the soliciting transmission). The STA may transmit the control transmission in response to the soliciting transmission based on the identified transmission parameter indicator. The control response transmission parameter set may include a frame format, a physical layer convergence protocol (PLCP) protocol data unit (PPDU) format, a bandwidth, a modulation scheme, an encoding scheme, a modulation and coding scheme (MCS), a number of spatial streams (NSS), and/or a PPDU duration. In some cases, the transmission parameter indicator may indicate disabling or resumption of extended range (ER) single user (SU) PPDU format usage.

### CROSS REFERENCES

The present Application for Patent claims priority to U.S. Provisional Patent Application No. 62/407,475 by Asterjadhi, et al., entitled “Dynamic Selection of Control Response Frame Parameters,” filed Oct. 12, 2016, and to U.S. Provisional Patent Application No. 62/417,250 by Asterjadhi, et al., entitled “Dynamic Selection of Control Response Frame Parameters, filed Nov. 3, 2016, and assigned to the assignee hereof.

### BACKGROUND

The present disclosure relates generally to wireless communication, and more specifically to dynamic selection of control response frame parameters.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e. Institute of Electrical and Electronics Engineers (IEEE) 802.11) network may include one or more access points (APs) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

A STA or AP may receive a soliciting frame from another STA or AP, and transmit a control frame to the STA or AP in response to the soliciting frame. The transmission parameters to be used for transmitting the control frame may be determined according to a set of static rules. In some cases, the STAs and/or APs may experience different or varying operating conditions, for example a link imbalance between communicating devices, asymmetric interference conditions, and so on. Current techniques may be inefficient and result in poor system performance in such operating conditions. Thus, improved techniques to determine transmission parameters are desired.

### SUMMARY

The described techniques relate to improved methods, systems, devices, or apparatuses that support dynamic selection of control response frame parameters.

A first station (which may also be an access point (AP) in some examples) may transmit a control transmission in response to a soliciting transmission from a second station (which may also be an AP). The control transmission may use an initial parameter value that is one of the parameter values in a control response transmission parameter set, which may include one or more of a physical layer convergence protocol (PLCP) protocol data unit (PPDU) format, a bandwidth, a modulation scheme, an encoding scheme, a modulation and coding scheme (MCS), a number of spatial streams (NSS), or a PPDU duration. The first and second stations may exchange a transmission parameter indicator that indicates a change to one or more parameters in the control response transmission parameter set from the initial parameter value to a second parameter value. The first station may transmit the transmission parameter indicator to the second station, the transmission parameter indicating to the second station a change in the control response transmission parameter set that is used for generating control response frames that are to be sent by the first station. The second station may also transmit the transmission parameter indicator to the first station, the transmission parameter indicating to the first station a change in the control response transmission parameter set that is used for generating control response frames that are to be used by the first station. The transmission parameter indicator may be sent in a header of a media access control (MAC) protocol data unit (MPDU), an aggregated MPDU (A-MPDU), or in an operating mode indicator (OMI) field. The first station may then receive a soliciting transmission from the second station, then transmit, in response to the soliciting transmission, one or more control response transmissions based on the transmission parameter that was exchanged with the second station.

The first station may also receive a soliciting frame formatted according to an extended range (ER) single user (SU) PPDU. If the second station supports receptions of transmissions in the ER SU PPDU format and the most recently received transmission received from the second station was transmitted according to an ER SU PPDU format, the first station may transmit an immediate response frame (e.g., an acknowledgement (ACK) frame or control response frame) in response to the soliciting frame, where the immediate response frame is formatted according to the ER SU PPDU format.

That is, a wireless device (e.g., a station (STA)) may receive a transmission soliciting a control transmission (e.g., a soliciting transmission). The STA may identify a transmission parameter indicator, which may indicate a change in one or more parameters in a control response transmission parameter set (e.g., a set of parameters used for control transmissions in response to the soliciting transmission). The STA may transmit the control transmission in response to the soliciting transmission based on the identified transmission parameter indicator. The control response transmission parameter set may include a frame format, a PPDU format, a bandwidth, a modulation scheme, an encoding scheme, a MCS, a NSS, and/or a PPDU duration. In some cases, the transmission parameter indicator may indicate disabling or resumption of PPDU format usage (e.g., ER SU PPDU format usage).

A method of wireless communication is described. The method may include identifying, at a first station, a transmission parameter indicator, wherein the transmission parameter indicator indicates whether there is a change in one or more parameters in a control response transmission parameter set from an initial value used by the first station for control frames to a second value and transmitting a control frame to a second station in response to a received soliciting frame based at least in part on the identified transmission parameter indicator.

An apparatus for wireless communication is described. The apparatus may include means for identifying a transmission parameter indicator, wherein the transmission parameter indicator indicates whether there is a change in one or more parameters in a control response transmission parameter set from an initial value used by the apparatus for control frames to a second value and means for transmitting a control frame to a station in response to a received soliciting frame based at least in part on the identified transmission parameter indicator.

Another apparatus for wireless communication is described. The apparatus may include a processor, memory in electronic communication with the processor, and instructions stored in the memory. The instructions may be operable to cause the processor to identify a transmission parameter indicator, wherein the transmission parameter indicator indicates whether there is a change in one or more parameters in a control response transmission parameter set from an initial value used by the apparatus for control frames to a second value and transmit a control frame to a station in response to a received soliciting frame based at least in part on the identified transmission parameter indicator.

A non-transitory computer-readable medium for wireless communication is described. The non-transitory computer-readable medium may include instructions operable to cause a processor of a station to identify a transmission parameter indicator, wherein the transmission parameter indicator indicates whether there is a change in one or more parameters in a control response transmission parameter set from an initial value used by the station for control frames to a second value and transmit a control frame to a second station in response to a received soliciting frame based at least in part on the identified transmission parameter indicator.

Some examples of the method, apparatus, and non-transitory computer-readable medium described above may further include processes, features, means, or instructions for transmitting a frame to the second station, wherein the transmitted frame comprises the transmission parameter indicator.

In some examples of the method, apparatus, and non-transitory computer-readable medium described above, the transmission parameter indicator may be transmitted in a header or in an information element of a MPDU, an A-MPDU, or in an OMI control field, or a PPDU, to indicate to the second station that the station will transmit the control frame to the second station using the second parameter value.

In some examples of the method, apparatus, and non-transitory computer-readable medium described above, the transmission parameter indicator may be transmitted in an information element of the frame.

Some examples of the method, apparatus, and non-transitory computer-readable medium described above may further include processes, features, means, or instructions for receiving a frame from the second station, wherein the transmission parameter indicator may be identified from the received frame.

In some examples of the method, apparatus, and non-transitory computer-readable medium described above, the transmission parameter indicator may be received in a header or in an information element of a MPDU, an A-MPDU, an OMI control field, or a PPDU to indicate to the second station that the station may be to use the second value for the one or more parameters in the control response transmission parameter set to transmit the control frame to the second station.

In some examples of the method, apparatus, and non-transitory computer-readable medium described above, the transmission parameter indicator may be received in an information element of the frame.

Some examples of the method, apparatus, and non-transitory computer-readable medium described above may further include processes, features, means, or instructions for receiving the transmission parameter indicator, the transmission parameter indicator comprising an indication of a suspension or a resumption of use of an ER SU PPDU format.

Some examples of the method, apparatus, and non-transitory computer-readable medium described above may further include processes, features, means, or instructions for transmitting the control frame in response to the received soliciting frame using the ER SU PPDU format based at least in part on the received transmission parameter indicator indicating the resumption of use of the ER SU PPDU format.

Some examples of the method, apparatus, and non-transitory computer-readable medium described above may further include processes, features, means, or instructions for transmitting the control frame in response to the received soliciting frame using a non-ER SU PPDU format based at least in part on the received transmission parameter indicator indicating the suspension of use of the ER SU PPDU format.

Some examples of the method, apparatus, and non-transitory computer-readable medium described above may further include processes, features, means, or instructions for refraining from transmitting the control frame in response to the received soliciting frame using the ER SU PPDU format based at least in part on the received transmission parameter indicator the suspension of use of the ER SU PPDU format.

Some examples of the method, apparatus, and non-transitory computer-readable medium described above may further include processes, features, means, or instructions for identifying that the received soliciting frame may be formatted according to an ER SU PPDU format. Some examples of the method, apparatus, and non-transitory computer-readable medium described above may further include processes, features, means, or instructions for transmitting the control frame formatted according to the ER SU PPDU format based at least in part on identifying that the second station supports reception of frames formatted according to the ER SU PPDU format.

Some examples of the method, apparatus, and non-transitory computer-readable medium described above may further include processes, features, means, or instructions for transmitting the control frame formatted according to the ER SU PPDU format based at least in part on determining that a most recent frame from the second station to the station was transmitted according to the ER SU PPDU format.

Some examples of the method, apparatus, and non-transitory computer-readable medium described above may further include processes, features, means, or instructions for transmitting the control frame formatted according to the ER SU PPDU format based at least in part on determining that a most recent non-control frame from the second station to the station was transmitted according to the ER SU PPDU format.

In some examples of the method, apparatus, and non-transitory computer-readable medium described above, the transmission parameter indicator comprises an OM control subfield including a NSS subfield, or a channel bandwidth subfield, or an ER SU PPDU disable subfield, or a combination thereof.

Some examples of the method, apparatus, and non-transitory computer-readable medium described above may further include processes, features, means, or instructions for determining to wait a predefined period of time after identifying the transmission parameter indicator before transmitting the control frame to the second station using the second value for the one or more parameters in the control response transmission parameter set.

In some examples of the method, apparatus, and non-transitory computer-readable medium described above, the predefined period of time comprises an end of a current transmission opportunity, or a fixed duration, or a combination thereof.

In some examples of the method, apparatus, and non-transitory computer-readable medium described above, the one or more parameters in the control response transmission parameter set comprise a PPDU format, or a MCS, or a bandwidth, or a NSS, or a PPDU duration, or a combination thereof.

In some examples of the method, apparatus, and non-transitory computer-readable medium described above, the initial value for the one or more parameters comprises an ER SU PPDU format, and the second value for the one or more parameters comprises a legacy (non-HT (duplicate)) PPDU format; or the initial value for the one or more parameters comprises the legacy (non-HT (duplicate)) PPDU format, and the second value for the one or more parameters comprises the ER SU PPDU format.

In some examples of the method, apparatus, and non-transitory computer-readable medium described above, the control frame in response to the received soliciting frame comprises an ACK, or a block acknowledgement (BA), or a multi-station block acknowledgement (M-BA), or a clear to send (CTS), or a contention free (CF)-End, or a CF-End ACK, or a combination thereof.

In some examples of the method, apparatus, and non-transitory computer-readable medium described above, the control frame may be transmitted in response to the received soliciting frame an interframe spacing after the received soliciting frame.

Some examples of the method, apparatus, and non-transitory computer-readable medium described above may further include processes, features, means, or instructions for identifying that the received soliciting frame uses dual carrier modulation (DCM). Some examples of the method, apparatus, and non-transitory computer-readable medium described above may further include processes, features, means, or instructions for encoding the control frame to be transmitted in response to the received soliciting frame using DCM.

Some examples of the method, apparatus, and non-transitory computer-readable medium described above may further include processes, features, means, or instructions for identifying that the second station supports a 106-tone ER SU PPDU format. Some examples of the method, apparatus, and non-transitory computer-readable medium described above may further include processes, features, means, or instructions for transmitting the control frame using the 106-tone HE ER SU PPDU format.

### BRIEF DESCRIPTION OF THE DRAWINGS

FIG. 1 illustrates an example of a wireless communication system that supports dynamic selection of control response frame parameters in accordance with aspects of the present disclosure.

FIG. 2 illustrates an example of a wireless communication system that supports dynamic selection of control response frame parameters in accordance with aspects of the present disclosure.

FIG. 3 illustrates an example of a timing diagram that supports dynamic selection of control response frame parameters in accordance with aspects of the present disclosure.

FIG. 4 illustrates an example of a timing diagram that supports dynamic selection of control response frame parameters in accordance with aspects of the present disclosure.

FIG. 5 illustrates an example of a control field format that supports dynamic selection of control response frame parameters in accordance with aspects of the present disclosure.

FIG. 6 illustrates an example of a timing diagram that supports dynamic selection of control response frame parameters in accordance with aspects of the present disclosure.

FIG. 7 illustrates an example of a timing diagram that supports dynamic selection of control response frame parameters in accordance with aspects of the present disclosure.

FIG. 8 illustrates an example of a process flow that supports dynamic selection of control response frame parameters in accordance with aspects of the present disclosure.

FIGS. 9 through 11 show block diagrams of a device that supports dynamic selection of control response frame parameters in accordance with aspects of the present disclosure.

FIG. 12 illustrates a block diagram of a system including a station (STA) that supports dynamic selection of control response frame parameters in accordance with aspects of the present disclosure.

FIGS. 13 through 15 illustrate methods for dynamic selection of control response frame parameters in accordance with aspects of the present disclosure.

### DETAILED DESCRIPTION

A receiver station (STA), which may also be an access point (AP) in some examples, may receive soliciting frames (e.g., a soliciting a physical layer convergence protocol (PLCP) protocol data unit (PPDU)) from another station, which may be a transmitting station. The receiver station and the transmitter stations, in some examples, may support high efficiency (HE) communications, such as HE PPDU frame formats. The receiver station and the transmitter stations may additionally support legacy PPDU formats, such as non-high throughput (HT) (duplicate) PPDU frame formats that are decodable by legacy devices, such that these legacy devices can set their network allocation vector (NAV), extended interframe space (EIFS), etc., appropriately upon reception of these non-HT (duplicate) frames. Certain HE PPDU frame formats, including an extend range single user PPDU (ER SU PPDU) frame format may enable robust modulation, which may provide approximately three dB to five dB, or more, of gain compared with reference to a legacy PPDU. In some examples, a receiver STA may not be able to transmit a legacy PPDU with enough power for the transmitter STA to successfully receive a response (e.g., an acknowledgement (ACK), non-acknowledgement (NACK), etc.), but a ER SU PPDU may still be successfully received by the transmitter STA. In some examples, the transmitter STA and receiver STA may experience different or varying operating conditions such as, for example, a link imbalance between the transmitter and receiver STA, asymmetric interference conditions experienced by the transmitter STA and the receiver STA, and so on.

Techniques to support dynamic selection of control response frame parameters described herein may address the above challenges. In one example, a transmitter STA may transmit an ER SU PPDU to a receiver STA that supports reception of such ER SU PPDUs. A receiver STA that receives an ER SU PPDU (e.g., that solicits an immediate response from the receiver STA) may respond with a PPDU that contains an immediate response. Examples of such immediate responses (e.g., control response transmissions) may include an ACK/NACK, a block acknowledgement (BA), a multi-station block acknowledgement (M-BA), a clear to send (CTS), a contention free (CF)-End, a CF-End ACK, or some combination of immediate responses. The PPDU format selected by the receiver STA to use for the immediate response may depend on certain conditions.

In some examples, if the receiver STA supports the generation of ER SU PPDUs and the receiver STA has not indicated to the transmitter STA that the receiver STA wants to send the control response frames in legacy format, the receiver STA may send the immediate response as an ER SU PPDU. In some examples, such indication that the receiver STA wants to send the control response frames in a legacy PPDU format may be explicitly signaled (such as by one or more bits) in a previously exchanged frame between the receiver STA and the transmitter STA. For example, an explicit indication may be carried in an operating mode indicator (OMI) A-Control Field, such as a transmitter OMI (TOMI) portion of the OMI A-Control field, in an operating mode notification (OMN) field, or another location of a frame sent by the receiver STA to the transmitter STA. In other examples, the indication may be carried by implicit signaling. For example, the absence of signaling by the receiver STA to the transmitter STA may indicate a default response should be for the receiver STA to transmit an ER SU PPDU.

In other examples, if the receiver STA does not support generation of ER SU PPDUs the receiver STA may transmit a legacy PPDU, such as a non-HT (duplicate) PPDU. In another example, the receiver STA may not support the generation of ER SU PPDUs, and the most recently sent indication sent to the transmitter STA indicates that the receiver STA intends to generate a control response frames in a legacy format, then the receiver STA may transmit a legacy PPDU.

In some examples, a transmitter STA that generates ER SU PPDUs and received an indication (e.g., an explicit indication) from the receiver STA regarding the type of PPDU format (e.g., ER SU PPDU, legacy PPDU, etc.) that the receiver STA intends to use to transmit, may use the indication when setting a duration/ID field and the transmission opportunity (TXOP) duration fields of the ER SU PPDUs that the transmitter STA will transmit to the receiver STA. In some examples, the transmitter STA may use the indication as described to account for variations in the control response lengths associated with an ER SU PPDU as compared to a legacy PPDU (or non-HT (duplicate) PPDU).

In some examples, a STA may send control frames in non-HT (or legacy) PPDU except when the control frame is a response to an ER SU, SU, or UL multi-user (MU) PPDU that uses STBC, in which case the control frame may use STBC and the same PPDU format as the soliciting PPDU (as a baseline). In other examples, the control frame may be an ACK, BA, or M-BA that is sent as a response to a trigger-based PPDU, in which case the control frame may be carried in another PPDU format supported by the intended receiver STA or STAs. In yet other examples, the control frame may be sent as a response to a PPDU containing a trigger frame (e.g., not an MU RTS), or an UL MU Response Scheduling A-Control field, in which case the control frame may be carried in a trigger-based PPDU format. Another example is where the control frame is an ACK sent in response to ER SU, SU, or UL MU PPDU containing a fine timing measurement (FTM) frame, in which case the ACK frame may be sent in the same PPDU format as the soliciting PPDU.

In still other examples, a STA may transmit an ER SU PPDU to a peer STA that supports its reception as indicated by the ER SU PPDU payload field of a HE Capabilities element received from the peer STA. However, a HE STA may not send an ER SU PPDU to a STA that does not support ER SU PPDUs. According to another example, a STA that is the intended receiver of an ER SU PPDU that solicits an immediate response may send the solicited response frame in an ER SU PPDU. However, the STA may not send the solicited response frame in the ER SU PPDU when the peer STA has explicitly signaled that it intends to generate control responses in non-HT (duplicate) PPDU, in which case the STA may send them in a non-HT (duplicate) PPDU.

In other examples, a STA may generate control response frames for received ER SU PPDUs that indicate an explicit switch to legacy non-HT (duplicate) PPDU by using a bit in the TOMI portion of a OMI A-Control field. A STA may also use a bit in an OMN frame for such feature. The switch may take effect in the same manner as one or more other TOMI parameters. For example, the switch may take effect after the end of the current TXOP. In other examples, a receiver STA may use non-HT PPDUs in response to ER SU PPDUs as long as the Legacy Switch bit is ON, or may use ER SU PPDUs as long as either no Legacy Switch is received or a Legacy Switch bit set to OFF is received. In yet other examples, the transmitter STA may account for the expected response type when calculating Duration/ID and TXOP_DURATION field values.

In still further examples, and as further described herein, a bandwidth (BW) of a control response frame sent by a STA within a TXOP may be the same as the soliciting PPDU. However, when a CTS frame is sent in response to a RTS frame with Dynamic_BW, the BW may be reduced to a smaller BW. In other examples, frames sent by TXOP holder may have smaller BW than previously transmitted frames of that TXOP. In some examples, the frames sent by the TXOP holder may have a smaller BW, but may not have a larger BW. In some examples, the smaller BW may apply for control responses sent by an AP as a response to a trigger-based PPDU. A station may use a BW signaling associated with a transmitter address (TA) for control frame that are sent in non-HT PPDUs with a BW of greater than 20 MHz. In other examples, a station may use a BW signaling TA for control frames that are sent in non-HT PPDUs with a BW of 20 MHz. In yet other examples, a station may not use a BW signaling TA for PPDU formats other than for non-HT PPDUs.

Another example includes exceptions for selecting modulation coding scheme (MCS) and/or number of spatial streams (NSS), for example for a <MCS, NSS> tuple. In one example, for a trigger-based PPDU, MCS and/or NSS selection may be based on the soliciting trigger or UL MU Response A-Control field. In another example, the MCS and/or NSS selection may be based on a control frame sent in response to a trigger-based PPDU, where in the MCS/NSS may be a tuple supported by the intended receivers. In some examples, a control frame sent in response to an ER SU PPDU may be equal to <MCS0, 1>. In other examples, for example where asymmetric link conditions are detected, a STA may signal the MCS for control responses in a soliciting PPDU, for example, for a link adaptation procedure, and the MCS of the control response frame may be the MCS specified in the soliciting PPDU. In another example, the responding STA may use DCM in a control response frame if DCM is supported for transmission by the STA and if DCM is supported for reception by the receiving STA. In some examples, the PPDU soliciting the control frame may use DCM.

Aspects of the disclosure are initially described in the context of a wireless communications system. Examples of wireless systems supporting dynamic selection of control transmission parameters, as well as example parameter indications and timing diagrams are then described. Aspects of the disclosure are further illustrated by and described with reference to apparatus diagrams, system diagrams, and flowcharts that relate to dynamic selection of control response frame parameters

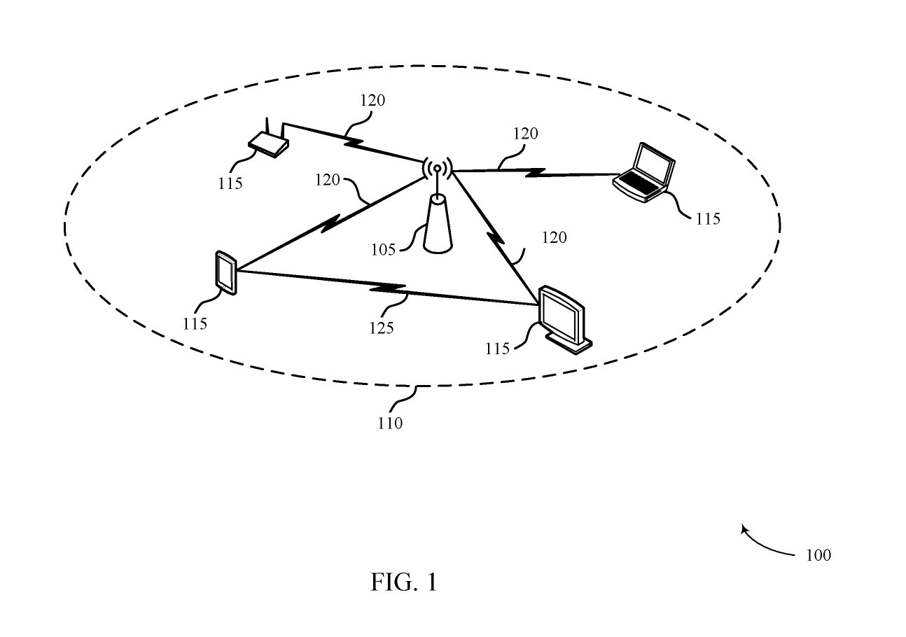

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, phones, personal digital assistant (PDAs), other handheld devices, netbooks, notebook computers, tablet computers, laptops, display devices (e.g., TVs, computer monitors, etc.), printers, etc. The AP 105 and the associated stations 115 may represent a BSS or an ESS. The various STAs 115 in the network are able to communicate with one another through the AP 105. Also shown is a coverage area 110 of the AP 105, which may represent a BSA of the WLAN 100. An extended network station associated with the WLAN 100 may be connected to a wired or wireless distribution system that may allow multiple APs 105 to be connected in an ESS. In some cases, AP (e.g., including an AP 105) and STA (e.g., including a STA 115) may be used interchangeably throughout the present disclosure. That is, a STA 115 may resemble aspects of an AP 105 and techniques described with reference to a STA 115 may be applicable to an AP 105, and vice versa. For example, where the term station or STA is used, it may be understood that a STA may operate as or share certain features of an AP in some examples, and vice versa.

In some examples, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver to not transmit for the duration of the primary transmission. Thus, RTS/CTS may help mitigate a hidden node problem. In some cases, a soliciting frame may refer to a transmission or frame associated with a subsequent response transmission or frame (e.g., a control response frame). For example a soliciting frame may solicit a control frame (e.g., ACK, a block acknowledgement (BA), a multi-station block acknowledgement (M-BA), a CTS, a CF-End, a CF-End ACK, etc.) in response. In some cases, a control frame (e.g., sent in response to a soliciting frame) and a control response frame may be used interchangeably.

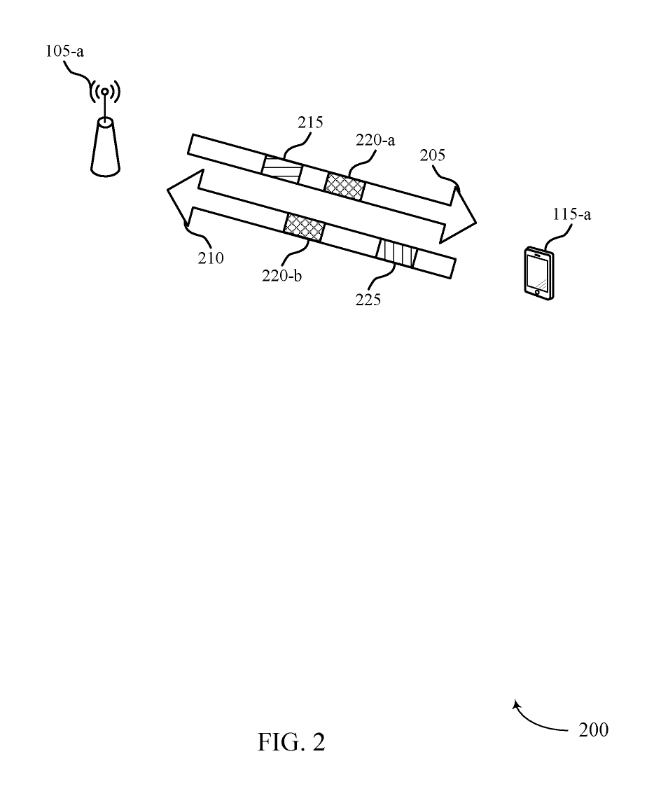

FIG. 2 illustrates an example of a wireless communication system 200 for dynamic selection of control response frame parameters. Wireless communication system 200 may utilize transmission parameters for sending and/or receiving control communications (e.g., control frames 215, control response frames 225).

Transmission parameters (e.g., selection rules) for control response frames 225 may be static based on some conditions. For example, control frames 215 may be carried in a high throughput (HT) PPDU when the control frame 215 is sent using a space-time block coding (STBC) PPDU if a soliciting frame uses STBC, when an ACK (or NACK), BA, M-BA sent by an AP as a response to a trigger-based PPDU, and when control frame 215 is sent in response to a PPDU that contains a trigger frame or an uplink multiple user (MU) response A-Control field. Additionally, the bandwidth of control response frames 225 may be sent by STA 115-a within a TXOP that is the same as the soliciting PPDU, except for when a CTS frame is sent in response to a request-to-send (RTS) frame with dynamic bandwidth, in which case the bandwidth may be reduced. Further, the MCS may follow a static condition based on the soliciting PPDU's MCS. A STA (e.g., STA 115-a, which in some examples may be a HE STA) may follow a base line MCS/NSS tuple (e.g., <MCS, NSS>). Alternatively, MCS for trigger-based PPDU may be determined by the soliciting trigger or uplink MU response A-Control field. Control frames 215 sent in response to a trigger-based PPDU may be a tuple supported by the intended receivers. Control frames 215 may be sent in response to an extended range (ER) single user (SU) PPDU may result in yet another MCS/NSS tuple (e.g., <MCS0, 1>). Finally, the responding STA (e.g., STA 115-a) may use DCM in a control response frame 225 if DCM is supported in a transmission by the STA (e.g., STA 115-a) and in reception by the receiving STA (e.g., AP 105-a).

Under some conditions such as link imbalance, asymmetric interference conditions (e.g., between AP 105-a and STA 115-a), and so on, it may be beneficial for wireless communication system 200 to support dynamic transmission parameters for control response frames 225. For example, wireless communication system 200 may support signaling to enable dynamic selection of transmission rates for communications between AP 105-a and STA 115-a. In some cases, such signaling may include operating mode indications 220. Operating mode indications 220 may allow a receiving STA (e.g., STA 115-a) and the transmitting STA (e.g., AP 105-a) to indicate parameters for control response transmissions (e.g., control response frames 225). For example, an operating mode indication 220 may indicate parameters such as a PPDU format (e.g., ER, HT non-duplicate/non-ER, etc.), MCS, bandwidth (BW), etc. for control response frames 225. The transmitting STA (e.g., AP 105-a) may calculate TXOPs based on the intended transmission parameters.

In some cases, the soliciting STA may indicate transmission parameters for a control response frame from the responding STA. That is, AP 105-a may transmit an operating mode indication 220-a in a downlink transmission 205. The operating mode indication 220-a may be sent as a separate indication from a control frame 215, as illustrated, or in some cases, the operating mode indication 220-a may be part of a control frame 215. The responding STA (e.g., STA 115-a) may use the transmission parameters indicated in operating mode indication 220-a for transmission of control response frames 225. In other cases, STA 115-a may indicate parameters (e.g., via operating mode indication 220-b) for its own control response frame 225. Operating mode indication 220-b may be sent in an uplink transmission 210 to AP 105-a, and may indicate transmission parameters for control response frames 225 in response to received control frame(s) 215. The operating mode indication 220-b may sent as a separate indication from a control response frame 225, as illustrated, or in some cases, the operating mode indication 220-b may be part of a control response frame 225. Additionally or alternatively, an operating mode indication 220 may be sent as header information piggybacked with an MPDU, or sent in an operating mode indication (OMI) field. Further, parameters, or parameter changes, may take effect after a pre-determined time after the reception of an operating mode indication 220. As an example, the pre-determined time may be the end of an ongoing or current TXOP, or some other absolute interval. In yet another example, a control response frame 225 may indicate control frame(s) 215 transmission rules or transmission parameters. Such transmission parameters may take effect in an interframe space (e.g., a short interframe space (SIFS)), at the end of a TXOP, etc.

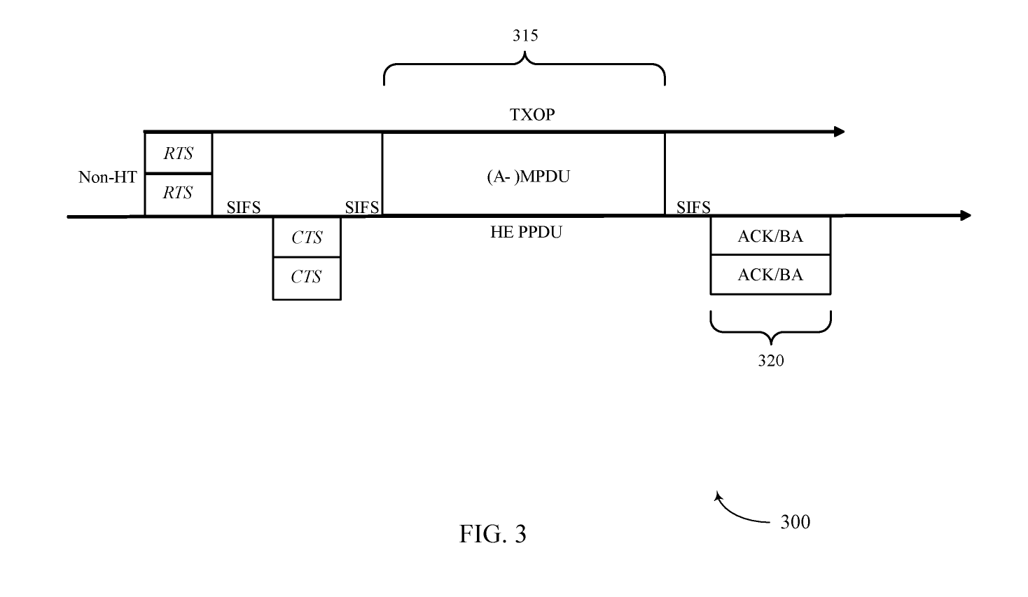

FIG. 3 illustrates an example of a timing diagram 300 for dynamic selection of control response frame parameters. Rules or conditions may determine control frame PPDU selection. For example, an AP 105 or soliciting STA 115 may select any format for sending control frames as a response to trigger-based PPDUs. In some cases, control wrapper frames may be deprecated or avoided. A HE STA 115 may transmit using a variety of PPDU formats according to a variety of transmission parameters (e.g., channel width, MCS, NSS, DCM, etc.) Selection of values for these transmission parameters may be based at least in part on the capabilities of an intended receiver (e.g., a receiving STA, AP, etc.), capabilities of the transmitter (e.g., STA, AP, etc.), or other considerations. For example, a HE STA 115 may take such capabilities or considerations into account when selecting transmission parameters.

As an example, PPDU formats used by the HE STA 115 may include non-HT, HT, VHT PPDUs. A HE STA 115 may transmit non-HT, HT, VHT PPDUs according to a predefined set of rules, which in some cases may represent a default or baseline set of rules. For example, a HE STA 115 may transmit a HE SU PPDU or a HE ER SU PPDU (e.g., 242-tone HE ER SU PPDU) to a peer HE STA 115 according to one set of predetermined rules. Further, a HE AP 105 may transmit DL MU PPDUs according to a second set of predefined rules such as, for example, a set of HE DL MU Operation rules. Additionally, a HE non-AP STA may transmit HE trigger-based PPDUs according to a third set of predefined rules such as, for example, a set of UL MU Operation rules.

In some cases, a HE capabilities element may include fields indicating a PPDU format. For example, a HE STA 115 (e.g., which may be a STA or AP) may transmit a HE ER SU PPDU (e.g., a 106-tone HE ER SU PPDU) to a peer STA 115 if the HE STA 115 has received, from the peer STA 115, an HE capabilities element with the ER SU PPDU payload field having a predetermined bit value (e.g., equal to 1). In another example, a HE non-AP STA may transmit a HE UL MU PPDU to a peer STA if it has received, from the peer STA, a HE capabilities element with the UL MU PPDU support field having a predetermined bit value (e.g., equal to 1). In other cases (e.g., when an indication in the HE capabilities field, including the ER SU PPDU payload field and/or UL MU PPDU support field, does not have the predetermined bit value (e.g., not equal to 1), when a HE capabilities element is not received, etc.) the STA may use a different PPDU format.

A HE STA 115 may send control frames in non-HT PPDU format following a predefined set of rules (e.g., a set of rate selection for control frame rules), subject to one or more of the predefined set of exceptions that follow. According to a first exception to the predefined set of rules, a control frame sent in response to an ER SU, SU, or UL MU PPDU that uses STBC may be carried in the same format as the soliciting PPDU. According to a second exception to the predefined set of rules, a control frame sent by the AP as a response to an HE trigger-based PPDU may be carried in any PPDU format supported by the intended receivers (e.g., receiving STAs 115). According to a third exception to the predefined set of rules, a control frame sent as a response to a HE PPDU, containing a non-MU RTS trigger frame or an UL MU response scheduling A-Control field, may be carried in a HE trigger-based PPDU. According to a fourth exception to the predefined set of rules, an ACK frame sent as a response to an ER SU, SU, or UL MU PPDU containing a FTM frame may be sent in the same PPDU format as the soliciting PPDU. According to a fifth exception to the predefined set of rules, a control frame sent as a response to a soliciting ER SU PPDU may be carried in an ER SU PPDU. However, when the most recent PPDU sent by the responding STA to the soliciting STA after association was not a HE ER SU PPDU, the control frame may be carried in a non-HT PPDU. According to a sixth exception to the predefined set of rules, a control frame sent as a response to a soliciting non-ER SU PPDU may be carried in a non-HT PPDU. However, when the most recent PPDU sent (e.g., successfully) by the responding STA to the soliciting STA after associated was an HE ER SU PPDU, the control frame may be carried in a HE ER SU PPDU.

In some cases, PPDU format switching between non-HT and ER SU PPDU formats may occur in subsequent TXOPs. A STA that solicits a control frame from a peer STA may account for the PPDU format of the control frame to calculate or estimate an expected duration of the TXOP.

In some cases, a HE STA 115 may send control frames in a non-HT PPDU with the exception of the following conditions. In some cases, the control frame may use STBC and the same PPDU format as the soliciting PPDU 315 when the control frame is a response to an ER SU, SU, or uplink MU PPDU that uses STBC. The control frame may be carried in any other PPDU format supported by the intended receiver(s) if the control frame is an ACK, BA, or M-BA (320) that is sent as a response to a trigger-based PPDU. In other cases, the control frame may be carried in a trigger-based PPDU format if the control frame is sent as a response to a PPDU containing a trigger frame (e.g., not MU RTS) or as a response to an uplink MU response scheduling A-Control field. In yet other cases, an ACK frame may be sent in the same PPDU format as the soliciting PPDU when the control frame is an ACK sent in response to ER SU, SU, or uplink MU PPDU containing a FTM frame.

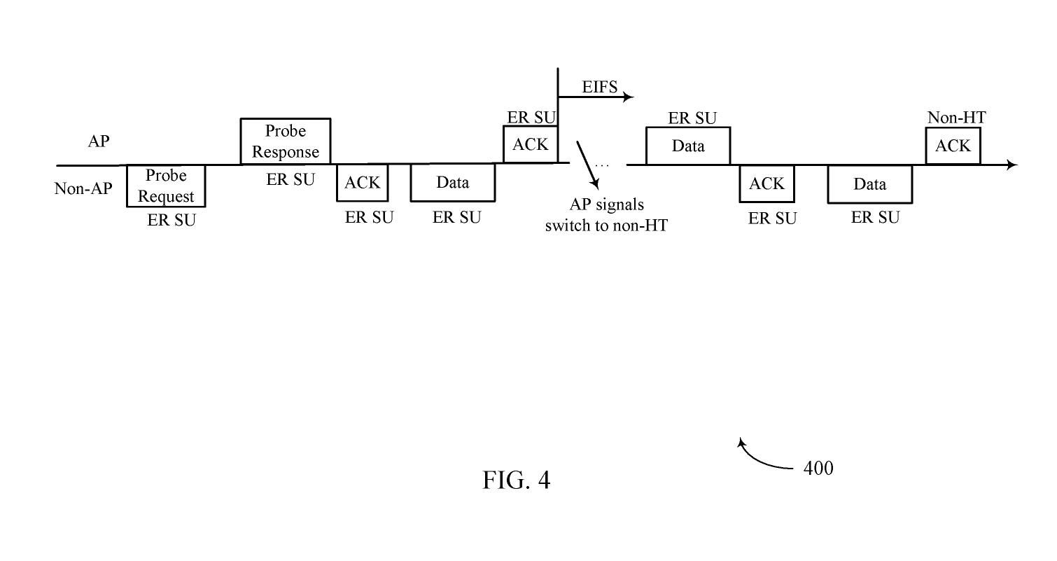

FIG. 4 illustrates an example of a timing diagram 400 for dynamic selection of control response frame parameters. In some cases, ER SU PPDUs may cover extended ranges and may help negate adverse effects associated with scenarios where reverse link imbalance exists. Both the transmission and reception of ER SU PPDUs may be optional. Multiple formats for control response frames sent in response to ER SU PPDUs may be used. For example, the receiving STA 115 may choose (e.g., indicate to the transmitting STA 115 or AP 105) which format will be used for the control response frame(s). For example, the receiving STA 115 may select an ER SU PPDU when the transmit power is insufficient to close the reverse link (which may exist, for example, because of asymmetric interference or other link imbalances). In another example, the receiving STA 115 may select a non-HT PPDU (e.g., a legacy or predefined PPDU) when the transmit power is sufficient to close the reverse link.

A HE STA 115 may transmit an ER SU PPDU to a peer or receiving STA 115 that supports its reception as indicated by the ER SU PPDU payload field of the HE capabilities element received from the peer STA. A HE STA may not send an ER SU PPDU to a STA that does not support ER SU PPDUs. Further, a HE STA that is the intended receiver of an ER SU PPDU soliciting an immediate response may send the solicited response frame in an ER SU PPDU. Alternatively, The HE STA may send the solicited response frame in a non-HT (e.g., duplicate) PPDU when the peer STA has explicitly signaled that it intends to generate control responses in non-HT PPDU.

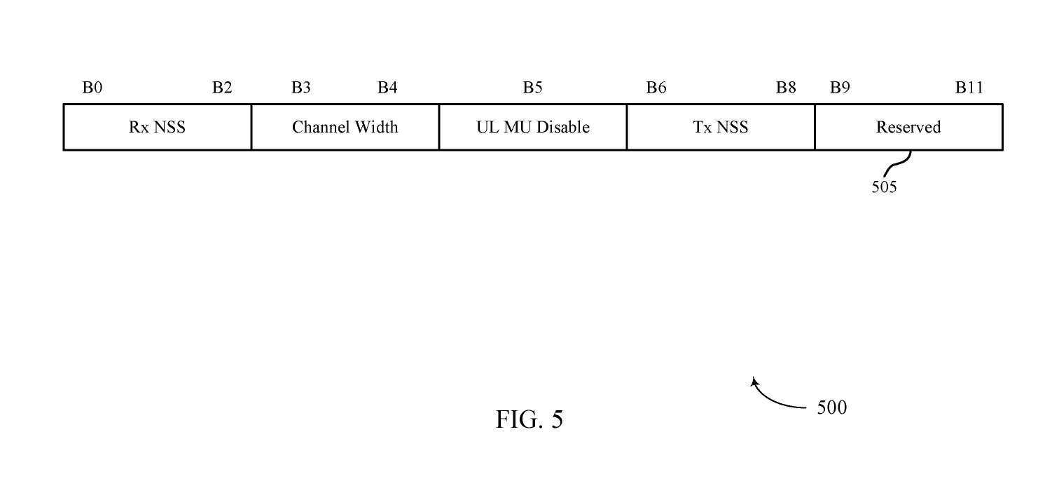

FIG. 5 illustrates an example of a control field format 500 for dynamic selection of control response frame parameters. A STA 115 that generates a control response frame in response to ER SU PPDUs may explicitly indicate a change in PPDU format (e.g., a switch to legacy non-HT (duplicate) PPDUs) via an indication in a reserved field 505. For example, a bit in the TOMI portion of the operation mode indicator (OMI) A-Control field or a bit in the OMN frame may indicate the change. The PPDU format change or switch may take effect in a similar fashion as other TOMI parameters. That is, the change may take effect after the end of a current TXOP. Further, the receiving STA 115 may use non-HT PPDUs in response to received ER SU PPDUs as long as the PPDU format change bit is ON. Alternatively, the receiving STA 115 may use ER SU PPDUs in response when no switch indication is received or when the PPDU format change bit is OFF. The transmitting STA 115 or AP 105 may account for the expected response type (e.g., the expected PPDU format) when calculating a duration/ID and/or TXOP duration field values.

In some cases, the PPDU format change bit may be referred to as a format disable subfield or an ER SU disable subfield. Further, a transmission parameter indicator may indicate or refer to a ER SU disable subfield. The ER SU disable subfield may indicate whether ER SU PPDU reception is suspended or resumed by the STA 115. For example, the ER SU disable subfield may be set to 1 to indicate that ER SU PPDU reception is suspended. Alternatively, the ER SU PPDU disable subfield may be set to 0 to indicate that ER SU PPDU reception is resumed. In some cases, a STA 115 may receive a transmission parameter indicator (e.g., in a ER SU disable subfield) that indicates that the STA 115 is to disable ER SU PPDU reception, and the STA 115 may refrain from responding, using an ER SU PPDU, to a subsequent soliciting transmission from the second station. In other cases, a STA 115 may receive a transmission parameter indicator indicating resumption of an ER SU PPDU reception, and may transmit control transmissions in response to received soliciting transmission using ER SU PPDUs.

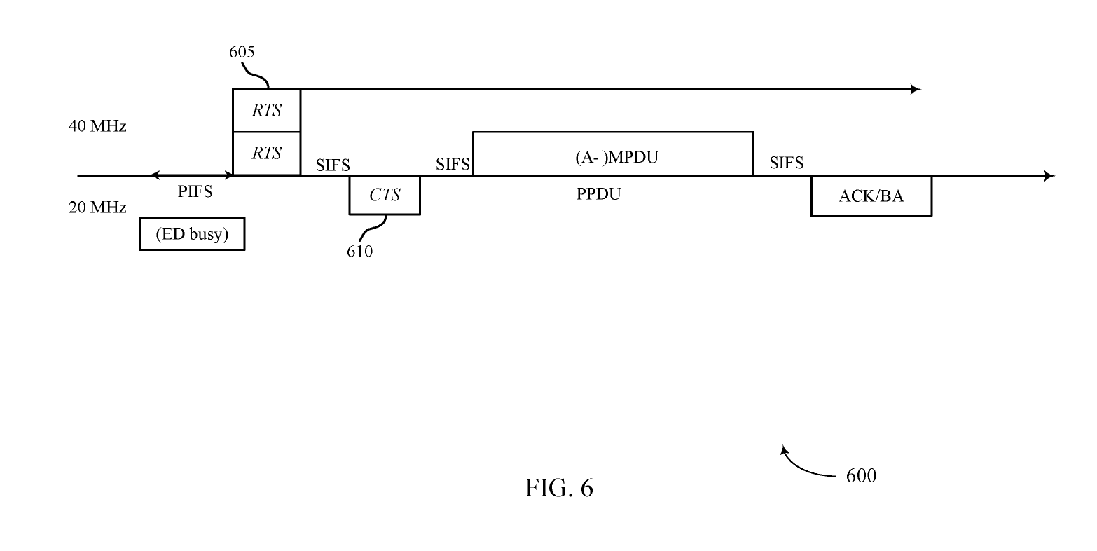

FIG. 6 illustrates an example of a timing diagram 600 for dynamic selection of control response frame parameters. Bandwidth selection for control frames may also follow a set of rules or be determined by certain conditions. For a HE STA 115, for example, the bandwidth of control response frames sent by a STA 115 within a TXOP may be the same as the bandwidth of the soliciting PPDU. Alternatively, a CTS frame 610 may be sent with dynamic bandwidth (e.g., a reduced bandwidth) in response to an RTS frame 605. Frames sent by a TXOP holder (e.g., a transmitting STA 115) may have a reduced bandwidth than previously transmitted frame of that TXOP. For example, control responses sent by an AP 105 as a response to a trigger-based PPDU may utilize a smaller bandwidth (e.g., 20 MHz in the present example). A HE STA 115 may use bandwidth-signaling TA for control frames sent in, for example, more than 20 MHz non-HT PPDUs. A HE STA 115 may use bandwidth-signaling TA for control frames sent in, for example, 20 MHz non-HT PPDUs. In some cases, a HE STA 115 may not use bandwidth-signaling TA for other PPDU formats. For example, a HE STA 115 may transmit greater than 20 MHz PPDUs in, for example, 2.4 GHz.

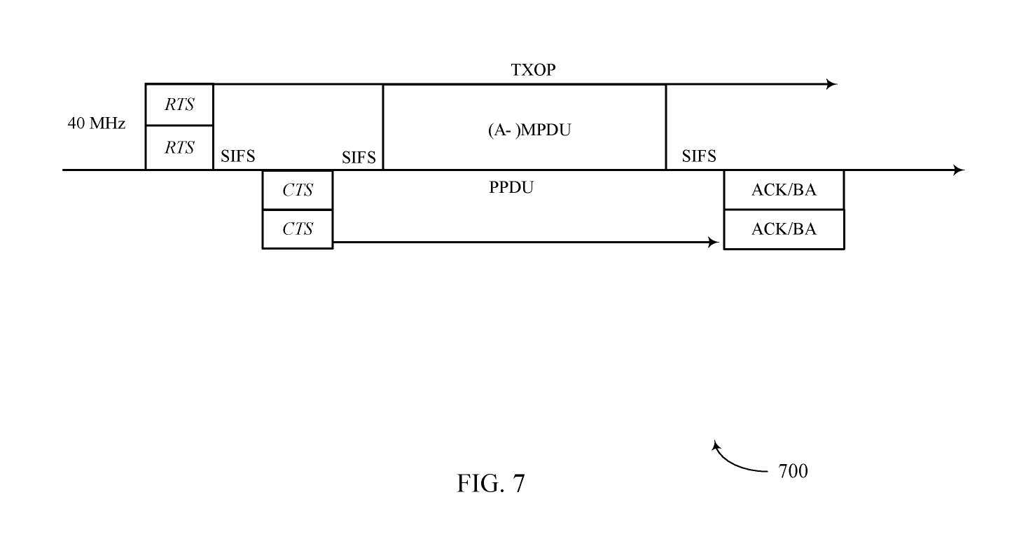

FIG. 7 illustrates an example of a timing diagram 700 for dynamic selection of control response frame parameters. MCS and/or NSS (e.g., a <MCS, NSS> tuple) selection for control frames may also follow a set of rules or be determined by certain conditions. For trigger-based PPDU, a <MCS, NSS> tuple may be determined based on the soliciting trigger or uplink MU response A-Control field. For a control frame sent in response to a trigger-based PPDU, the <MCS, NSS> tuple may be supported by the intended receivers. For a control frame sent in response to an ER SU PPDU, the <MCS, NSS> tuple may, in some cases, equal <MCS0, 1>.

Asymmetric links may have different <MCS, NSS> tuple selection rules based on various conditions. For example, the STA 115 may signal a MCS for control responses in a soliciting PPDU (e.g., similar to aspects of a HE link adaptation procedure, etc.). In such cases, the MCS of a control response frame may be the MCS specified in the soliciting PPDU. Further, a responding STA 115 may use DCM (e.g., DCM encoding) in a control response frame if DCM is supported by transmission from the STA 115 and in reception by the receiving STA 115 or if the frame soliciting the control response frame uses DCM. In some cases, the techniques described above may additionally apply to <HE-MCS, NSS> tuples in the <MCS, NSS> selection set.

In some cases, a HE STA 115 may follow predefined rules (e.g., rate selection constraints for HE STAs 115) for selecting the rate, MCS, NSS, etc., which in some cases may represent a first set of default or baseline rules followed by HE STA 115 for selecting values associated with these parameters. In some cases, the HE STA 115 may follow other predefined rules (e.g., channel width selection for control frames, channel width in non-HT and non-HT duplicate PPDUs) for selecting the channel width or bandwidth of transmitted PPDUs, which in some cases may represent a second set of default or baseline rules followed by HE STA 115 for selecting values associated with these parameters.

In some examples, one or more of the first or second set of default or baseline rules followed by HE STA 115 regarding rate, MCS, NSS, and channel width selection may be subject to one or more of the predefined set of exceptions that follow. According to a first exception to the predefined set of rules, a <MCS, NSS> for a control frame sent in response to an ER SU PPDU may be <MCS0, 1> and the bandwidth may be, for example, 20 MHz. According to a second exception to the predefined set of rules, a rate and bandwidth for a CTS frame sent as a response to a MU RTS may be predefined (e.g., according to CTS response to MU RTS predefined rules). According to a third exception to the predefined set of rules, a MCS, NSS, and bandwidth selection rules for trigger-based PPDUs may be predefined (e.g., according to STA behavior predefined rules). Finally, according to a fourth exception to the predefined set of rules, NSS and bandwidth selection rules may be further constrained according to a certain indication (e.g., an operating mode indication, or a notification of operating mode changes).

In other examples, a HE STA that transmits a HE PPDU may use a <HE-MCS, NSS> tuple determined to be supported by the receiving STA. A<HE-MCS, NSS> tuple may be supported if it is reported as supported in a supported HE-MCS and NSS set field in a HE capabilities element received from that STA. In some cases, when the supported HE-MCS and NSS set of the receiving STA or STAs is unknown, the transmitting STA may transmit using a <HE-MCS, NSS> tuple in a basic HE-MCS and NSS set. The STA may select a <HE-MCS, NSS> tuple from the basic HE-MCS and NSS set when protection is desired or required (e.g., according to predefined protection mechanisms) and may select a <HE-MCS, NSS> tuple from the operational HE-MCS and NSS set parameter of the intended receiver when protection is not required.

If a control response frame is to be transmitted within a HE SU PPDU or a HE MU PPDU, the channel width (e.g., CH_BANDWIDTH parameter of TXVECTOR) may be selected first according to predefined rules (e.g., channel width selection for control frames predefined rules). Further, the <HE-MCS, NSS> tuple may be selected from a set of <HE-MCS, NSS> tuples (e.g., from a candidate MCS set).

In some examples, a HE STA 115 may not transmit a PPDU with a channel width greater than some predetermined threshold, which may depend on an operating bandwidth associated with the HE STA 115 (e.g., 20 MHz in the 2.4 GHz band, etc.).

In other examples, a HE STA 115 may transmit a HE PPDU with DCM to a peer STA if the HE STA 115 has received, from the peer STA, a HE capabilities element with a DCM encoding reception field equal to 1. The HE STA 115 may not transmit a HE PPDU with DCM to the peer STA. Additionally, a HE STA 115 may transmit a HE trigger-based PPDU with DCM according to predefined rules (e.g., STA behavior predefined rules).

In some examples, a HE STA 115 that sends a control frame in an ER SU PPDU format may use DCM encoding. For example, the HE STA 115 may use DCM encoding if the most recent PPDU sent by the HE STA 115 to the soliciting STA after association used DCM. Otherwise, the HE STA 115 may not use DCM. The HE STA 115 may also use an ER SU PPDU format (e.g., a 106-tone ER SU PPDU) if the most recent PPDU sent by the HE STA 115 to the soliciting STA after association was a similar ER SU PPDU format (e.g., a 106-tone ER SU PPDU).

In some cases, switching of values associated with the transmission parameters described with reference to FIG. 7 may occur in subsequent TXOPs. A STA that solicits a control frame from a peer STA may account for the transmission parameter of the control frame to estimate or calculate the expected duration of the TXOP.

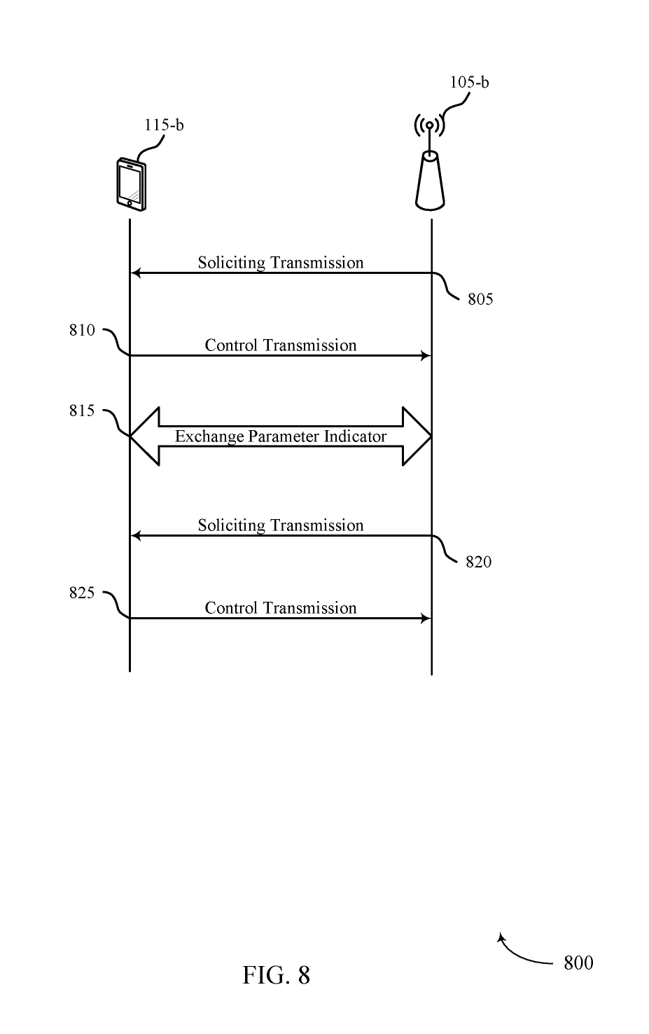

FIG. 8 illustrates an example of a process flow 800 for dynamic selection of control response frame parameters. Specifically, process flow 800 may illustrate an example of a change in control response frame parameters for control transmissions in response to soliciting transmissions.

In some cases, the techniques discussed below may also apply between two STAs 115. For example, AP 105-b may be a second STA 115 or STA 115-b may be a second AP 105.

At step 805, STA 115-b may receive a soliciting transmission from AP 105-b.

At step 810, STA 115-b may transmit a control transmission in response to the soliciting transmission of step 805. The control transmission may be sent using initial or predetermined control response transmission parameter set. For example, the control response transmission parameter set may include a frame format, a PLCP PPDU format, a bandwidth, a modulation scheme, an encoding scheme, a MCS, a NSS, and/or a PPDU duration. In some cases, the initial parameter value associated with the PPDU format may indicate an ER SU PPDU and the second parameter value may indicate a legacy (e.g., non-HT (duplicate)) PPDU.

At step 815, STA 115-b may exchange, with a second STA (e.g., AP 105-b), a transmission parameter indicator. The transmission parameter indicator may indicate a change in one or more parameters in the control response parameter set from an initial value to a second value. The transmission parameter may indicate to AP 105-b a change in the control response transmission parameter set that is used for generating control response frames that are to be sent by STA 115-b. In some cases, STA 115-b may receive the transmission parameter indicator in a header of a MPDU, an A-MPDU, an OMI field, and/or a PPDU to indicate that STA 115-b is to use the second parameter value to transmit the subsequent control response transmissions to AP 105-b. In some cases, the transmission parameter indicator may include an operating mode (OM) control subfield. Alternatively, the STA 115-b may transmit or indicate the transmission parameter indicator via the means described above.

At step 820, STA 115-b may receive a second soliciting transmission from AP 105-b.

At step 825, STA 115-b may transmit one or more additional control response transmissions based at least in part on the parameter indicator exchanged at step 815. That is, the additional or subsequent control response transmissions may be sent with different transmission parameters than those used for the control transmission response to the soliciting message of step 805. In some cases, STA 115-b may wait a predefined period of time after exchanging the transmission parameter indicator with AP 105-b (e.g., step 815) before transmitting the additional or subsequent control response transmissions to AP 105-b using the second parameter value. The predefined period of time may include an end of a current TXOP and/or a fixed duration. Further, the additional or subsequent control response transmissions may include an ACK, a BA, a M-BA, a CTS, a CF-End, and/or a CF-End ACK.

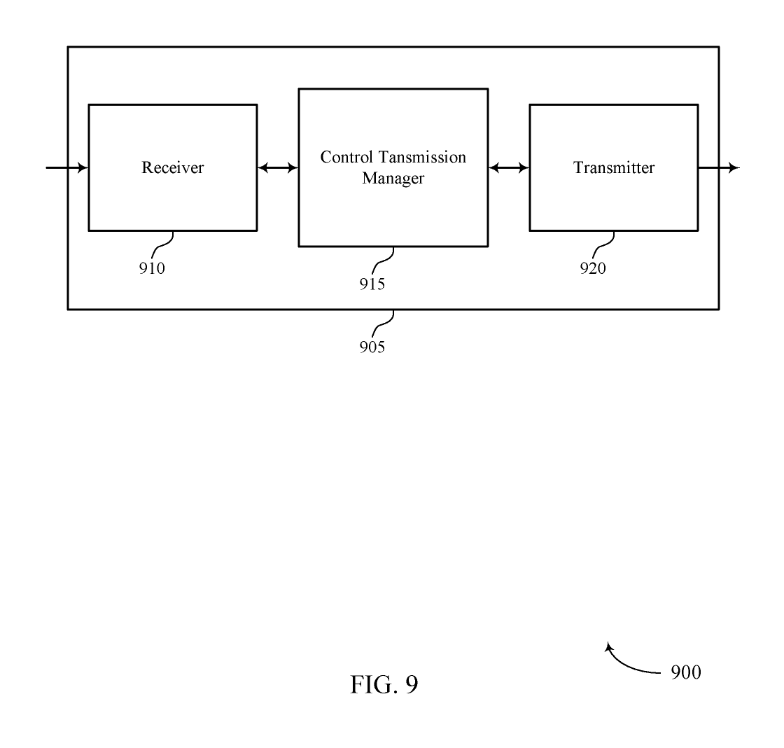

FIG. 9 shows a block diagram 900 of a wireless device 905 that supports dynamic selection of control response frame parameters in accordance with aspects of the present disclosure. Wireless device 905 may be an example of aspects of a STA 115 as described herein. Wireless device 905 may include receiver 910, control transmission manager 915, and transmitter 920. Wireless device 905 may also include a processor. Each of these components may be in communication with one another (e.g., via one or more buses).

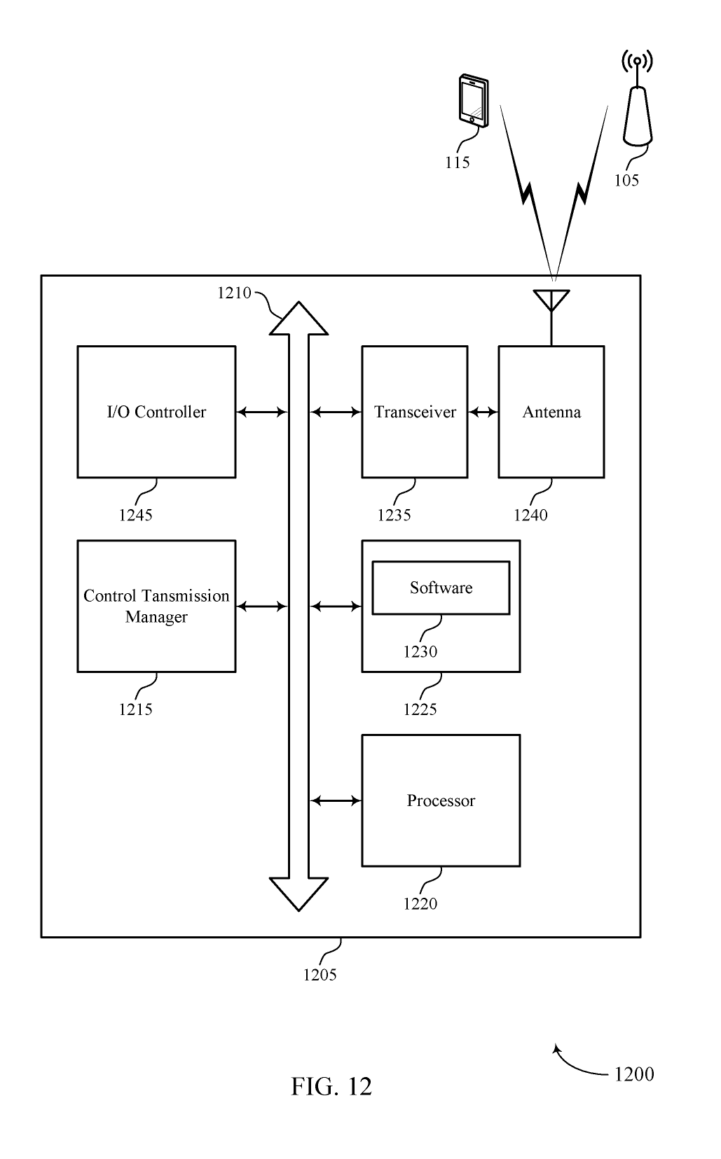

Receiver 910 may receive information such as packets, user data, or control information associated with various information channels (e.g., control channels, data channels, and information related to dynamic selection of control response frame parameters, etc.). Information may be passed on to other components of the device. The receiver 910 may be an example of aspects of the transceiver 1235 described with reference to FIG. 12. The receiver 910 may utilize a single antenna or a set of antennas.

Control transmission manager 915 may be an example of aspects of the control transmission manager 1215 described with reference to FIG. 12. Control transmission manager 915 and/or at least some of its various sub-components may be implemented in hardware, software executed by a processor, firmware, or any combination thereof. If implemented in software executed by a processor, the functions of the control transmission manager 915 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The control transmission manager 915 and/or at least some of its various sub-components may be physically located at various positions, including being distributed such that portions of functions are implemented at different physical locations by one or more physical devices. In some examples, control transmission manager 915 and/or at least some of its various sub-components may be a separate and distinct component in accordance with various aspects of the present disclosure. In other examples, control transmission manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Control transmission manager 915 may identify a transmission parameter indicator, where the transmission parameter indicator indicates whether there is a change in one or more parameters in a control response transmission parameter set from an initial value used by the station for control frames to a second value and transmit a control frame to a second station in response to a received soliciting frame based on the identified transmission parameter indicator.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may utilize a single antenna or a set of antennas.

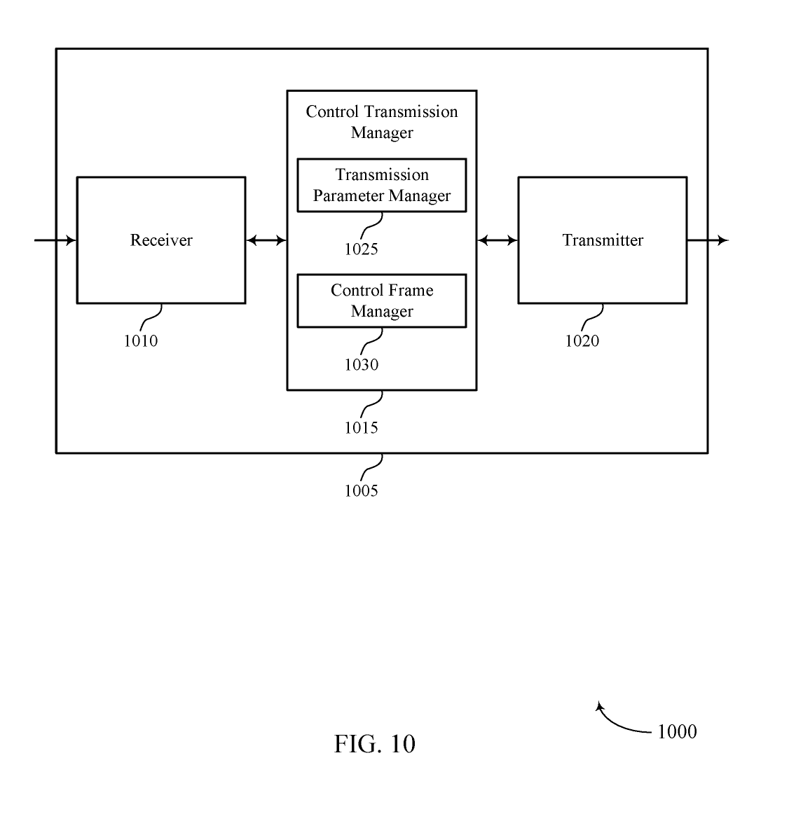

FIG. 10 shows a block diagram 1000 of a wireless device 1005 that supports dynamic selection of control response frame parameters in accordance with aspects of the present disclosure. Wireless device 1005 may be an example of aspects of a wireless device 905 or a STA 115 as described with reference to FIG. 9. Wireless device 1005 may include receiver 1010, control transmission manager 1015, and transmitter 1020. Wireless device 1005 may also include a processor. Each of these components may be in communication with one another (e.g., via one or more buses).

Receiver 1010 may receive information such as packets, user data, or control information associated with various information channels (e.g., control channels, data channels, and information related to dynamic selection of control response frame parameters, etc.). Information may be passed on to other components of the device. The receiver 1010 may be an example of aspects of the transceiver 1235 described with reference to FIG. 12. The receiver 1010 may utilize a single antenna or a set of antennas.

Control transmission manager 1015 may be an example of aspects of the control transmission manager 1215 described with reference to FIG. 12. Control transmission manager 1015 may also include transmission parameter manager 1025 and control frame manager 1030.

Transmission parameter manager 1025 may identify a transmission parameter indicator, where the transmission parameter indicator indicates whether there is a change in one or more parameters in a control response transmission parameter set from an initial value used by the station for control frames to a second value, transmit a frame to the second station, where the transmitted frame includes the transmission parameter indicator, and receive a frame from the second station, where the transmission parameter indicator is identified from the received frame. In some cases, the transmission parameter indicator is transmitted in a header of a MPDU, an A-MPDU, or in an OMI control field, or a PPDU, to indicate to the second station that the station will transmit the control frame to the second station using the second parameter value. In some cases, the transmission parameter indicator is received in a header of a MPDU, an A-MPDU, an OMI control field, or a PPDU to indicate to the second station that the second station is to use the second value for the one or more parameters in the control response transmission parameter set to transmit the control frame to the station. In some cases, the transmission parameter indicator is transmitted in an information element of the frame. In some cases, the transmission parameter indicator is received in an information element of the frame. In some cases, the transmission parameter indicator includes an OM control subfield including a NSS subfield, or a channel bandwidth subfield, or an ER SU PPDU disable subfield, or a combination thereof.

Control frame manager 1030 may transmit a control frame to a second station in response to a received soliciting frame based on the identified transmission parameter indicator, or the initial value for the one or more parameters includes the legacy (non-HT (duplicate)) PPDU format, and the second value for the one or more parameters includes the ER SU PPDU format. In some cases, the one or more parameters in the control response transmission parameter set include a PPDU format, or a modulation and coding scheme (MCS), or a bandwidth, or a NSS, or a PPDU duration, or a combination thereof. In some cases, the initial value for the one or more parameters includes an ER SU PPDU, and the second value for the one or more parameters includes a legacy (non-HT (duplicate)) PPDU format. In some cases, the control frame in response to the received soliciting frame includes an ACK, or a BA, or a M-BA, or a CTS, or a CF-End, or a CF-End ACK, or a combination thereof. In some cases, the control frame is transmitted in response to the received soliciting frame an interframe spacing after the received soliciting frame.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

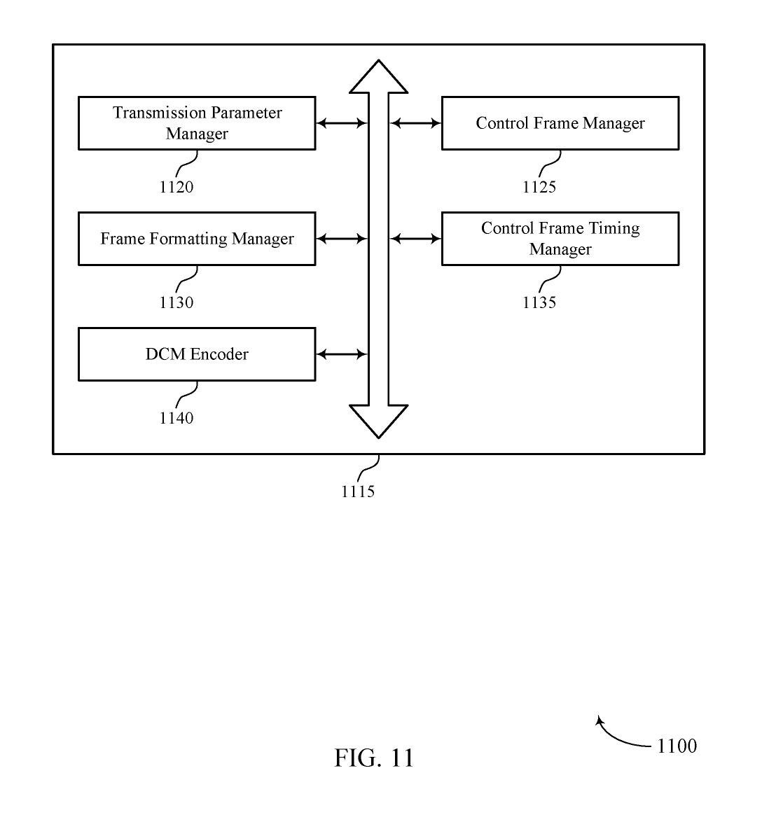

FIG. 11 shows a block diagram 1100 of a control transmission manager 1115 that supports dynamic selection of control response frame parameters in accordance with aspects of the present disclosure. The control transmission manager 1115 may be an example of aspects of a control transmission manager 915, a control transmission manager 1015, or a control transmission manager 1215 described with reference to FIGS. 9, 10, and 12. The control transmission manager 1115 may include transmission parameter manager 1120, control frame manager 1125, frame formatting manager 1130, control frame timing manager 1135, and DCM encoder 1140. Each of these modules may communicate, directly or indirectly, with one another (e.g., via one or more buses).

Transmission parameter manager 1120 may identify a transmission parameter indicator, where the transmission parameter indicator indicates whether there is a change in one or more parameters in a control response transmission parameter set from an initial value used by the station for control frames to a second value, transmit a frame to the second station, where the transmitted frame includes the transmission parameter indicator, and receive a frame from the second station, where the transmission parameter indicator is identified from the received frame. In some cases, the transmission parameter indicator is transmitted in a header or in an information element of a MPDU, an A-MPDU, or in an OMI control field, or a PPDU, to indicate to the second station that the station will transmit the control frame to the second station using the second parameter value. In some cases, the transmission parameter indicator is received in a header or in an information element of MPDU, an A-MPDU, an OMI control field, or a PPDU to indicate to the second station that the second station is to use the second value for the one or more parameters in the control response transmission parameter set to transmit the control frame to the station. In some cases, the transmission parameter indicator includes an OM control subfield including a NSS subfield, or a channel bandwidth subfield, or an ER SU PPDU disable subfield, or a combination thereof.

Control frame manager 1125 may transmit a control frame to a second station in response to a received soliciting frame based on the identified transmission parameter indicator, or the initial value for the one or more parameters includes the legacy (non-HT (duplicate)) PPDU format, and the second value for the one or more parameters includes the ER SU PPDU format. In some cases, the one or more parameters in the control response transmission parameter set include a PPDU format, or a modulation and coding scheme (MCS), or a bandwidth, or a NSS, or a PPDU duration, or a combination thereof. In some cases, the initial value for the one or more parameters includes an ER SU PPDU, and the second value for the one or more parameters includes a legacy (non-HT (duplicate)) PPDU format. In some cases, the control frame in response to the received soliciting frame includes an ACK, or a BA, or a M-BA, or a CTS, or a CF-End, or a CF-End ACK, or a combination thereof. In some cases, the control frame is transmitted in response to the received soliciting frame an interframe spacing after the received soliciting frame.

Frame formatting manager 1130 may receive the transmission parameter indicator, the transmission parameter indicator including an indication of a suspension or a resumption of use of an ER SU PPDU, transmit the control frame in response to the received soliciting frame using the ER SU PPDU format based on the received transmission parameter indicator indicating the resumption of use of the ER SU PPDU format, transmit the control frame in response to the received soliciting frame using a non-ER SU PPDU format based on the received transmission parameter indicator indicating the suspension of use of the ER SU PPDU format, refrain from transmitting the control frame in response to the received soliciting frame using the ER SU PPDU format based on the received transmission parameter indicator the suspension of use of the ER SU PPDU format, identify that the received soliciting frame is formatted according to an ER SU PPDU, transmit the control frame formatted according to the ER SU PPDU format based on identifying that the second station supports reception of frames formatted according to the ER SU PPDU format, transmit the control frame formatted according to the ER SU PPDU format based on determining that a most recent frame from the second station to the station was transmitted according to the ER SU PPDU format, transmit the control frame formatted according to the ER SU PPDU format based on determining that a most recent non-control frame from the second station to the station was transmitted according to the ER SU PPDU format, identify that the second station supports a 106-tone ER SU PPDU, and transmit the control frame using the 106-tone HE ER SU PPDU format.

Control frame timing manager 1135 may determine to wait a predefined period of time after identifying the transmission parameter indicator before transmitting the control frame to the second station using the second value for the one or more parameters in the control response transmission parameter set. In some cases, the predefined period of time includes an end of a current transmission opportunity, or a fixed duration, or a combination thereof.

DCM encoder 1140 may identify that the received soliciting frame uses DCM and encode the control frame to be transmitted in response to the received soliciting frame using DCM.

FIG. 12 shows a diagram of a system 1200 including a device 1205 that supports dynamic selection of control response frame parameters in accordance with aspects of the present disclosure. Device 1205 may be an example of or include the components of wireless device 905, wireless device 1005, or a STA 115 as described above, e.g., with reference to FIGS. 9 and 10. Device 1205 may include components for bi-directional voice and data communications including components for transmitting and receiving communications, including control transmission manager 1215, processor 1220, memory 1225, software 1230, transceiver 1235, antenna 1240, and I/O controller 1245. These components may be in electronic communication via one or more buses (e.g., bus 1210).

Processor 1220 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting dynamic selection of control response frame parameters).

Memory 1225 may include random access memory (RAM) and read only memory (ROM). The memory 1225 may store computer-readable, computer-executable software 1230 including instructions that, when executed, cause the processor to perform various functions described herein. In some cases, the memory 1225 may contain, among other things, a basic input/output system (BIOS) which may control basic hardware or software operation such as the interaction with peripheral components or devices.

Software 1230 may include code to implement aspects of the present disclosure, including code to support dynamic selection of control response frame parameters. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

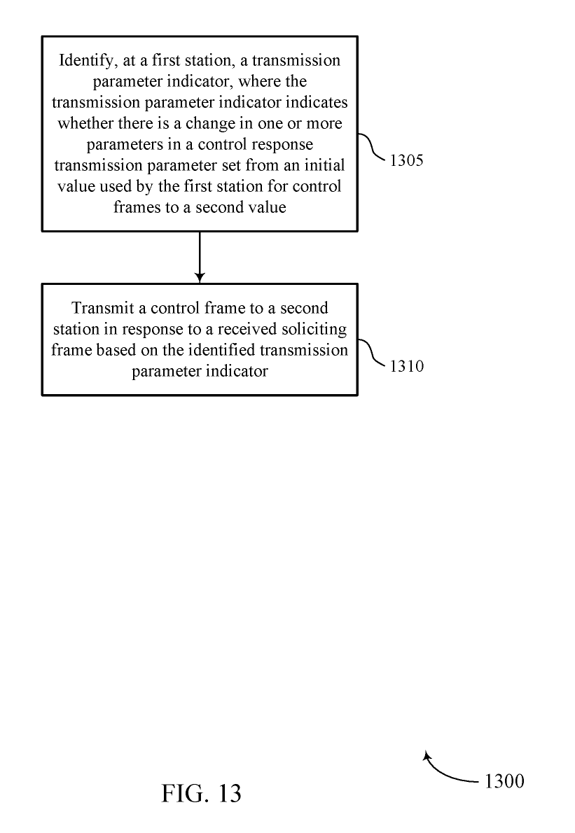

FIG. 13 shows a flowchart illustrating a method 1300 for dynamic selection of control response frame parameters in accordance with aspects of the present disclosure. The operations of method 1300 may be implemented by a STA 115 or its components as described herein. For example, the operations of method 1300 may be performed by a control transmission manager as described with reference to FIGS. 9 through 12. In some examples, a STA 115 may execute a set of codes to control the functional elements of the device to perform the functions described below. Additionally or alternatively, the STA 115 may perform aspects of the functions described below using special-purpose hardware.

At 1305 the STA 115 may identify a transmission parameter indicator, wherein the transmission parameter indicator indicates whether there is a change in one or more parameters in a control response transmission parameter set from an initial value used by the station for control frames to a second value. The operations of 1305 may be performed according to the methods described herein. In certain examples, aspects of the operations of 1305 may be performed by a transmission parameter manager as described with reference to FIGS. 9 through 12.

At 1310 the STA 115 may transmit a control frame to a second station in response to a received soliciting frame based at least in part on the identified transmission parameter indicator. The operations of 1310 may be performed according to the methods described herein. In certain examples, aspects of the operations of 1310 may be performed by a control frame manager as described with reference to FIGS. 9 through 12.

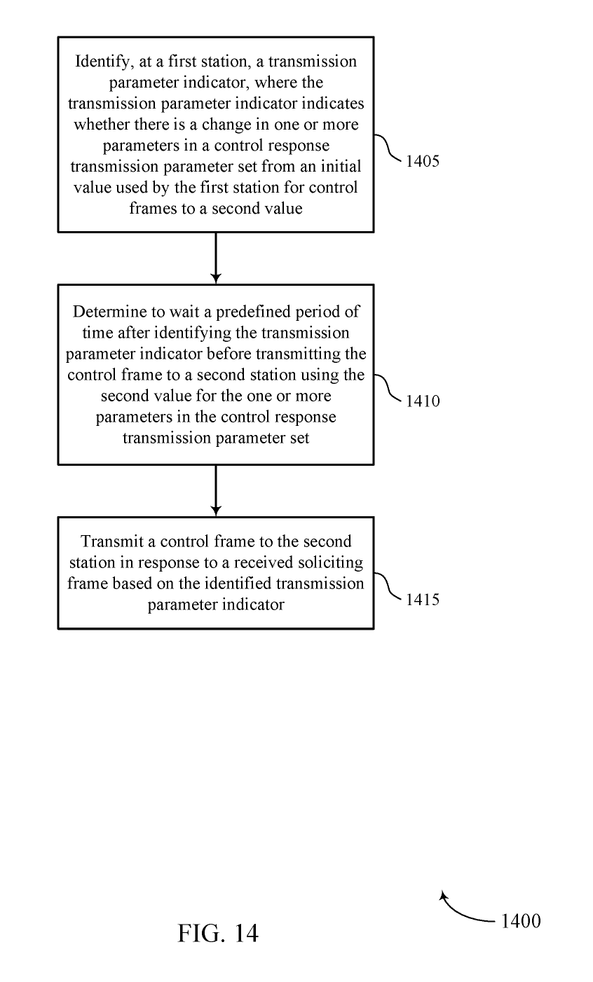

FIG. 14 shows a flowchart illustrating a method 1400 for dynamic selection of control response frame parameters in accordance with aspects of the present disclosure. The operations of method 1400 may be implemented by a STA 115 or its components as described herein. For example, the operations of method 1400 may be performed by a control transmission manager as described with reference to FIGS. 9 through 12. In some examples, a STA 115 may execute a set of codes to control the functional elements of the device to perform the functions described below. Additionally or alternatively, the STA 115 may perform aspects of the functions described below using special-purpose hardware.

At 1405 the STA 115 may identify a transmission parameter indicator, wherein the transmission parameter indicator indicates whether there is a change in one or more parameters in a control response transmission parameter set from an initial value used by the second station for control frames to a second value. The operations of 1405 may be performed according to the methods described herein. In certain examples, aspects of the operations of 1405 may be performed by a transmission parameter manager as described with reference to FIGS. 9 through 12.

At 1410 the STA 115 may determine to wait a predefined period of time after identifying the transmission parameter indicator before transmitting the control frame to the second station using the second value for the one or more parameters in the control response transmission parameter set. The operations of 1410 may be performed according to the methods described herein. In certain examples, aspects of the operations of 1410 may be performed by a control frame timing manager as described with reference to FIGS. 9 through 12.

At 1415 the STA 115 may transmit a control frame to a second station in response to a received soliciting frame based at least in part on the identified transmission parameter indicator. The operations of 1415 may be performed according to the methods described herein. In certain examples, aspects of the operations of 1415 may be performed by a control frame manager as described with reference to FIGS. 9 through 12.

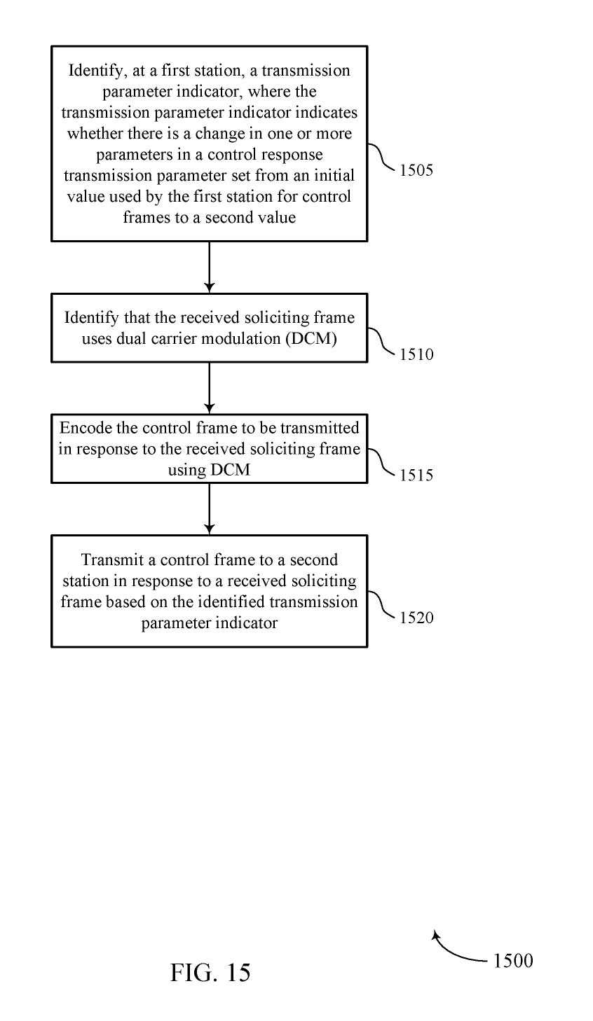

FIG. 15 shows a flowchart illustrating a method 1500 for dynamic selection of control response frame parameters in accordance with aspects of the present disclosure. The operations of method 1500 may be implemented by a STA 115 or its components as described herein. For example, the operations of method 1500 may be performed by a control transmission manager as described with reference to FIGS. 9 through 12. In some examples, a STA 115 may execute a set of codes to control the functional elements of the device to perform the functions described below. Additionally or alternatively, the STA 115 may perform aspects of the functions described below using special-purpose hardware.

At 1505 the STA 115 may identify a transmission parameter indicator, wherein the transmission parameter indicator indicates whether there is a change in one or more parameters in a control response transmission parameter set from an initial value used by the station for control frames to a second value. The operations of 1505 may be performed according to the methods described herein. In certain examples, aspects of the operations of 1505 may be performed by a transmission parameter manager as described with reference to FIGS. 9 through 12.

At 1510 the STA 115 may identify that the received soliciting frame uses DCM. The operations of 1510 may be performed according to the methods described herein. In certain examples, aspects of the operations of 1510 may be performed by a DCM encoder as described with reference to FIGS. 9 through 12.

At 1515 the STA 115 may encode the control frame to be transmitted in response to the received soliciting frame using DCM. The operations of 1515 may be performed according to the methods described herein. In certain examples, aspects of the operations of 1515 may be performed by a DCM encoder as described with reference to FIGS. 9 through 12.

At 1520 the STA 115 may transmit a control frame to a second station in response to a received soliciting frame based at least in part on the identified transmission parameter indicator. The operations of 1520 may be performed according to the methods described herein. In certain examples, aspects of the operations of 1520 may be performed by a control frame manager as described with reference to FIGS. 9 through 12.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communication system 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a processor;
memory in electronic communication with the processor; and
instructions stored in the memory and executable by the processor to cause the apparatus to:
identify a transmission parameter indicator, wherein the transmission parameter indicator indicates whether there is a change in one or more parameters in a control response transmission parameter set from an initial value used by the apparatus for control frames to a second value; and
transmit a control frame to a station in response to a received soliciting frame based at least in part on the identified transmission parameter indicator.

2. The apparatus of claim 1, wherein the instructions are further executable by the processor to cause the apparatus to:
transmit a frame to the station, wherein the transmitted frame comprises the transmission parameter indicator.

3. The apparatus of claim 2, wherein the transmission parameter indicator is transmitted in a header of a media access control (MAC) protocol data unit (MPDU), an aggregated MPDU (A-MPDU), or in an operating mode indicator (OMI) control field, or a physical layer convergence protocol (PLCP) protocol data unit (PPDU), to indicate to the station that the apparatus will transmit the control frame to the station using the second parameter value.

4. The apparatus of claim 2, wherein the transmission parameter indicator is transmitted in an information element of the frame.

5. The apparatus of claim 1, wherein the instructions are further executable by the processor to cause the apparatus to:
receive a frame from the station, wherein the transmission parameter indicator is identified from the received frame.

6. The apparatus of claim 5, wherein the transmission parameter indicator is received in a header of a media access control (MAC) protocol data unit (MPDU), an aggregated MPDU (A-MPDU), an operating mode indicator (OMI) control field, or a physical layer convergence protocol (PLCP) protocol data unit (PPDU) to indicate to the apparatus that the apparatus is to use the second value for the one or more parameters in the control response transmission parameter set to transmit the control frame to the station.

7. The apparatus of claim 5, wherein the transmission parameter indicator is received in an information element of the frame.

8. The apparatus of claim 1, wherein the instructions are further executable by the processor to cause the apparatus to:
receive the transmission parameter indicator, the transmission parameter indicator comprising an indication of a suspension or a resumption of use of an extended range (ER) single user (SU) physical layer convergence protocol (PLCP) protocol data unit (PPDU) format.

9. The apparatus of claim 8, wherein the instructions are further executable by the processor to cause the apparatus to:
transmit the control frame in response to the received soliciting frame using the ER SU PPDU format based at least in part on the received transmission parameter indicator indicating the resumption of use of the ER SU PPDU format.

10. The apparatus of claim 8, wherein the instructions are further executable by the processor to cause the apparatus to:
transmit the control frame in response to the received soliciting frame using a non-ER SU PPDU format based at least in part on the received transmission parameter indicator indicating the suspension of use of the ER SU PPDU format.

11. The apparatus of claim 8, wherein the instructions are further executable by the processor to cause the apparatus to:
refrain from transmitting the control frame in response to the received soliciting frame using the ER SU PPDU format based at least in part on the received transmission parameter indicator the suspension of use of the ER SU PPDU format.

12. The apparatus of claim 1, wherein the instructions are further executable by the processor to cause the apparatus to:
identify that the received soliciting frame is formatted according to an extended range (ER) single user (SU) physical layer convergence protocol (PLCP) protocol data unit (PPDU) format; and
transmit the control frame formatted according to the ER SU PPDU format based at least in part on identifying that the station supports reception of frames formatted according to the ER SU PPDU format.

13. The apparatus of claim 1, wherein the instructions are further executable by the processor to cause the apparatus to:
transmit the control frame formatted according to the ER SU PPDU format based at least in part on determining that a most recent frame from the station to the apparatus was transmitted according to the ER SU PPDU format.

14. The apparatus of claim 1, wherein the instructions are further executable by the processor to cause the apparatus to:
transmit the control frame formatted according to the ER SU PPDU format based at least in part on determining that a most recent non-control frame from the station to the apparatus was transmitted according to the ER SU PPDU format.

15. The apparatus of claim 1, wherein the transmission parameter indicator comprises an operating mode (OM) control subfield including a number of spatial streams (NS S) subfield, or a channel bandwidth subfield, or an extended range (ER) single user (SU) physical layer convergence protocol (PLCP) protocol data unit (PPDU) disable subfield, or a combination thereof.

16. The apparatus of claim 1, wherein the instructions are further executable by the processor to cause the apparatus to:
determine to wait a predefined period of time after identifying the transmission parameter indicator before transmitting the control frame to the station using the second value for the one or more parameters in the control response transmission parameter set.

17. The apparatus of claim 16, wherein the predefined period of time comprises an end of a current transmission opportunity, or a fixed duration, or a combination thereof.

18. The apparatus of claim 1, wherein the one or more parameters in the control response transmission parameter set comprise a physical layer convergence protocol (PLCP) protocol data unit (PPDU) format, or a modulation and coding scheme (MCS), or a bandwidth, or a number of spatial streams (NSS), or a PPDU duration, or a combination thereof.

19. The apparatus of claim 18, wherein:
the initial value for the one or more parameters comprises an extended range (ER) single user (SU) PPDU format, and the second value for the one or more parameters comprises a legacy (non-HT (duplicate)) PPDU format; or
the initial value for the one or more parameters comprises the legacy (non-HT (duplicate)) PPDU format, and the second value for the one or more parameters comprises the ER SU PPDU format.

20. The apparatus of claim 1, wherein the control frame in response to the received soliciting frame comprises an acknowledgement (ACK), or a block acknowledgement (BA), or a multi-station block acknowledgement (M-BA), or a clear to send (CTS), or a contention free (CF)-End, or a CF-End ACK, or a combination thereof.

21. The apparatus of claim 1, wherein the control frame is transmitted in response to the received soliciting frame an interframe spacing after the received soliciting frame.

22. The apparatus of claim 1, wherein the instructions are further executable by the processor to cause the apparatus to:
identify that the received soliciting frame uses dual carrier modulation (DCM); and
encode the control frame to be transmitted in response to the received soliciting frame using DCM.

23. The apparatus of claim 1, wherein the instructions are further executable by the processor to cause the apparatus to:
identify that the station supports a 106-tone extended range (ER) single user (SU) physical layer convergence protocol (PLCP) protocol data unit (PPDU) format; and
transmit the control frame using the 106-tone HE ER SU PPDU format.

24. A method for wireless communication at a first station, comprising:
identifying a transmission parameter indicator, wherein the transmission parameter indicator indicates whether there is a change in one or more parameters in a control response transmission parameter set from an initial value used by the first station for control frames to a second value; and
transmitting a control frame to a second station in response to a received soliciting frame based at least in part on the identified transmission parameter indicator.

25. The method of claim 24, further comprising:
transmitting a frame to the second station, wherein the transmitted frame comprises the transmission parameter.

26. The method of claim 24, further comprising:
receiving a frame from the second station, wherein the transmission parameter indicator is identified from the received frame.

27. The method of claim 24, further comprising:
receiving the transmission parameter indicator, the transmission parameter indicator comprising an indication of a suspension or a resumption of use of an extended range (ER) single user (SU) physical layer convergence protocol (PLCP) protocol data unit (PPDU) format.

28. The method of claim 24, further comprising:
identifying that the received soliciting frame is formatted according to an extended range (ER) single user (SU) physical layer convergence protocol (PLCP) protocol data unit (PPDU) format; and
transmitting the control frame formatted according to the ER SU PPDU format based at least in part on identifying that the second station supports reception of frames formatted according to the ER SU PPDU format.

29. An apparatus for wireless communication, comprising:
means for identifying a transmission parameter indicator, wherein the transmission parameter indicator indicates whether there is a change in one or more parameters in a control response transmission parameter set from an initial value used by a first station for control frames to a second value; and
means for transmitting a control frame to a second station in response to a received soliciting frame based at least in part on the identified transmission parameter indicator.

30. A non-transitory computer-readable medium storing code for wireless communication, the code comprising instructions executable by a processor to:
identify a transmission parameter indicator, wherein the transmission parameter indicator indicates whether there is a change in one or more parameters in a control response transmission parameter set from an initial value used by a first station for control frames to a second value; and
transmit a control frame to a second station in response to a received soliciting frame based at least in part on the identified transmission parameter indicator.
